(19) United States
(12) Patent Application Publication
(10) Pub. No.: US 2021/0043228 A1
(43) Pub. Date: Feb. 11, 2021

(54) MAGNETIC RECORDING MEDIUM AND MAGNETIC RECORDING AND REPRODUCING DEVICE

(71) Applicant: FUJIFILM Corporation, Tokyo (JP)

(72) Inventors: Kenji NAOI, Minami-ashigara-shi (JP); Takashi FUJIMOTO, Minami-ashigara-shi (JP)

(73) Assignee: FUJIFILM Corporation, Tokyo (JP)

(21) Appl. No.: 16/986,894

(22) Filed: Aug. 6, 2020

(30) Foreign Application Priority Data
Aug. 9, 2019 (JP) 2019-148126

(51) Int. Cl. G11B 5/706; G11B 5/714; G11B 5/008; G11B 5/735; G11B 5/584

(52) U.S. Cl. CPC G11B 5/70678; G11B 5/714; G11B 5/584; G11B 5/735; G11B 5/00813

(57) ABSTRACT

The magnetic recording medium includes a non-magnetic support; and a magnetic layer including a ferromagnetic powder, in which an anisotropic magnetic field Hk is more than 5.0 kOe and less than 7.5 kOe, an anisotropic magnetic field distribution is more than 0.75 and less than 1.20, the magnetic layer has a servo pattern, the ferromagnetic powder is a hexagonal strontium ferrite powder, and an average particle size of the hexagonal strontium ferrite powder is 9 nm to 20 nm.

### CROSS-REFERENCE TO RELATED APPLICATIONS

This application claims priority under 35 U.S.C 119 to Japanese Patent Application No. 2019-148126 filed on Aug. 9, 2019. The above application is hereby expressly incorporated by reference, in its entirety, into the present application.

### BACKGROUND OF THE INVENTION

### 1. Field of the Invention

The present invention relates to a magnetic recording medium and a magnetic recording and reproducing device.

### 2. Description of the Related Art

An increase in recording capacity (high capacity) of the magnetic recording medium is required in accordance with a great increase in information content in recent years. As a method for realizing high capacity, a technology of disposing a larger amount of data tracks on a magnetic layer by narrowing a width of the data track to increase recording density is used.

However, in a case where the width of the data track is narrowed and the recording and/or reproducing of data is performed by allowing the running of the magnetic recording medium in a magnetic recording and reproducing device, it is difficult that a magnetic head correctly follows the data tracks, and errors may easily occur in a case of recording and/or reproducing. Thus, as a method for reducing occurrence of such errors, a system of performing head tracking using a servo signal (hereinafter, referred to as a “servo system”) has been recently proposed and practically used (for example, see US5689384A).

### SUMMARY OF THE INVENTION

In a magnetic servo type servo system among the servo systems, a servo pattern is formed on a magnetic layer of a magnetic recording medium, and tracking of data tracks are performed with servo signals obtained by magnetically reading this servo pattern. More specific description is as follows.

First, a servo pattern formed on a magnetic layer is read by a servo signal reading element to obtain a servo signal. Next, a position of the magnetic head in the magnetic recording and reproducing device is controlled according to the obtained servo signal, and the magnetic head follows the data track. Accordingly, in a case of allow the magnetic recording medium to run in the magnetic recording and reproducing device for recording or reproducing data on the magnetic recording medium, it is possible to allow the magnetic head to follow the data track, even in a case where the position of the magnetic recording medium is changed with respect to the magnetic head. In order to enable more accurate recording of data on the magnetic recording medium and/or more accurate reproducing of data recorded on the magnetic recording medium, it is possible to increase an accuracy of the magnetic head following the data track in the servo system (hereinafter, referred to as “head positioning accuracy”).

The magnetic recording medium generally has a non-magnetic support, and a magnetic layer including ferromagnetic powder. In recent years, from a viewpoint of high-density recording suitability, a hexagonal strontium ferrite and is attracting attention as the ferromagnetic powder.

In view of the above circumstance, the inventors of the present invention have studied the improvement of the head positioning accuracy of the magnetic recording medium including a hexagonal strontium ferrite powder in a magnetic layer. As a result, it has been newly found that it is not easy to achieve both the improvement of the electromagnetic conversion characteristics, which is one of the characteristics required for the magnetic recording medium, and the improvement of the above-described head positioning accuracy.

An aspect of the invention provides for a magnetic recording medium that includes a hexagonal strontium ferrite powder in a magnetic layer and that can improve electromagnetic conversion characteristics and head positioning accuracy in a servo system.

According to an aspect of the invention, there is provided a magnetic recording medium comprising:

a non-magnetic support; and a magnetic layer including a ferromagnetic powder,

in which an anisotropic magnetic field Hk is more than 5.0 kOe and less than 7.5 kOe,

an anisotropic magnetic field distribution is more than 0.75 and less than 1.20,

the magnetic layer has a servo pattern,

the ferromagnetic powder is a hexagonal strontium ferrite powder, and an average

particle size of the hexagonal strontium ferrite powder is 9 nm to 20 nm.

In one aspect, the anisotropic magnetic field distribution of the magnetic recording medium may be 0.77 to 1.18.

In one aspect, the anisotropic magnetic field Hk of the magnetic recording medium may be 5.1 kOe to 7.3 kOe. For the unit, 1[Oe]=10³/4π[A/m]

In one aspect, the average particle size of the hexagonal strontium ferrite powder may be 10 nm to 20 nm.

In one aspect, the magnetic recording medium may further include a non-magnetic layer including a non-magnetic powder between the non-magnetic support and the magnetic layer.

In one aspect, the magnetic recording medium may further include a back coating layer including a non-magnetic powder on a surface of the non-magnetic support opposite to a surface provided with the magnetic layer.

In one aspect, the magnetic recording medium may be a magnetic tape.

In one aspect, the servo pattern may be a timing-based servo pattern.

According to another aspect of the invention, there is provided a magnetic recording and reproducing device comprising: the magnetic recording medium; and a magnetic head.

According to one aspect of the invention, it is possible to provide a magnetic recording medium that includes a hexagonal strontium ferrite powder in a magnetic layer and that can improve electromagnetic conversion characteristics and head positioning accuracy in a servo system. In addition, according to one aspect of the invention, it is possible to provide a magnetic recording and reproducing device including such a magnetic recording medium.

### BRIEF DESCRIPTION OF THE DRAWINGS

FIG. 1 shows an example of disposition of data bands and servo bands.

FIG. 2 shows a servo pattern disposition example of a linear-tape-open (LTO) Ultrium format tape.

### DESCRIPTION OF THE PREFERRED EMBODIMENTS

Magnetic Recording Medium

One embodiment of the invention relates to a magnetic recording medium including: a non-magnetic support; and a magnetic layer including a ferromagnetic powder, in which an anisotropic magnetic field Hk is more than 5.0 kOe and less than 7.5 kOe, an anisotropic magnetic field distribution is more than 0.75 and less than 1.20, the magnetic layer has a servo pattern, the ferromagnetic powder is a hexagonal strontium ferrite powder, and an average particle size of the hexagonal strontium ferrite powder is 9 nm to 20 nm.

The magnetic recording medium has a servo pattern on the magnetic layer. The servo pattern is a magnetized region and is formed by magnetizing a specific region of the magnetic layer by a servo write head. The shape of the region magnetized by the servo write head is determined by standards. It is considered that the head positioning accuracy in the servo system can be improved as the servo pattern is formed in a shape closer to the designed shape. However, a magnetic recording medium including a hexagonal strontium ferrite powder in a magnetic layer tends to be hardly magnetized, compared to a magnetic recording medium including a ferromagnetic powder used as the ferromagnetic powder of the magnetic layer in the related art (for example, hexagonal barium ferrite powder). This is considered to be one reason that the shape of the servo pattern formed on the magnetic layer including the hexagonal strontium ferrite powder is likely to deviate from a designed shape. Accordingly, the inventors assumes that the head positioning accuracy of the magnetic recording medium including the hexagonal strontium ferrite powder in the magnetic layer is easily reduced.

In contrast, the inventors have conducted intensive studies, and as a result, newly found that, it is possible to improve the head positioning accuracy of the magnetic recording medium having the magnetic layer including the hexagonal strontium ferrite powder in the servo system and to improve electromagnetic conversion characteristics, by using a hexagonal strontium ferrite powder having an average particle size of 9 nm to 20 nm as the hexagonal strontium ferrite powder and setting the anisotropic magnetic field Hk and the anisotropic magnetic field distribution of the magnetic recording medium in the ranges described above.

Hereinafter, the magnetic recording medium will be further described in detail.

Anisotropic magnetic field distribution and anisotropic magnetic field Hk

In the invention and the specification, the anisotropic magnetic field distribution of the magnetic recording medium is a value obtained by the following method by a remanence method using a vibrating sample magnetometer (VSM). The measurement is performed at a sample temperature of 23° C. By setting the atmosphere temperature around the sample to 23° C., the sample temperature can be set to 23° C. by realizing temperature equilibrium.

As the VSM, a double-axis VSM capable of measuring magnetization in two directions (x direction and y direction) is used. The “y direction” is a thickness direction of the magnetic recording medium, and the “x direction” is a longitudinal direction of a tape-shaped magnetic recording medium and is a radial direction of a disk-shaped magnetic recording medium.

A sample having a size that can be introduced into the VSM is cut out from the magnetic recording medium to be measured, and this sample is attached to a sample rod of the VSM for measurement.

First, an external magnetic field Hm is applied in the x direction to cause the sample to be saturation-magnetized (that is, the sample magnetic field in the y direction is set to zero), and then the applied magnetic field is set to zero to measure residual magnetization in the y direction. The external magnetic field Hm applied as described above may be any value that can cause the sample to be saturation-magnetized.

Then, after applying an external magnetic field H1 from an angle different from the x direction by 5°, the applied magnetic field is set to zero to measure the residual magnetization in the y direction. Here, H1 is smaller than Hm.

Then, after applying an external magnetic field H2 from the angle different from the x direction by 5° , the applied magnetic field is set to zero to measure the residual magnetization in they direction. Here, H2 is larger than H1.

Then, after applying the external magnetic field H3 from the angle different from the x direction by 5° , the applied magnetic field is set to zero to measure the residual magnetization in the y direction. Here, H3 is larger than H2.

As described above, the applied magnetic field in the x direction is changed in the order of H1→0→H2→0→H3→0 . . . to measure the residual magnetization in the y direction sequentially. The magnetic field applied in the x direction for each measurement is greater than the magnetic field applied for the immediately preceding measurement. The magnetic field applied in the x direction for the final measurement can be set randomly.

The residual magnetization in the y direction measured as described above is plotted on a graph (vertical axis: magnitude of the residual magnetization in the y direction, lateral axis: magnitude of the applied magnetic field in the x direction). The plot is differentiated, and the obtained differential curve is fit with a Voigt function to create an approximate curve. A value of the lateral axis at a peak position of the create approximate curve is defined as the anisotropic magnetic field Hk. The anisotropic magnetic field distribution is calculated with an equation of anisotropic magnetic field distribution=half-width of the approximate curve/anisotropic magnetic field Hk.

By the above method, the anisotropic magnetic field distribution and the anisotropic magnetic field Hk of the magnetic recording medium can be obtained.

The anisotropic magnetic field distribution of the magnetic recording medium is more than 0.75 and less than 1.20, from a viewpoint of improving the electromagnetic conversion characteristics and the head positioning accuracy. From a viewpoint of further improving the electromagnetic conversion characteristics and the head positioning accuracy, the anisotropic magnetic field distribution is preferably equal to or more than 0.76, more preferably equal to or more than 0.77, even more preferably equal to or more than 0.78, still preferably equal to or more than 0.79, and still more preferably equal to or more than 0.80. In addition, from viewpoints of further improving the electromagnetic conversion characteristics and the head positioning accuracy, the anisotropic magnetic field distribution is preferably equal to or less than 1.19, more preferably equal to or less than 1.18, even more preferably equal to or less than 1.17, still preferably equal to or less than 1.16, still more preferably equal to or less than 1.15, still even more preferably equal to or less than 1.14, and still further preferably equal to or less than 1.13, still further more preferably equal to or less than 1.12, still further even more preferably equal to or less than 1.11, and still even further more preferably equal to or less than 1.10. A method for adjusting the anisotropic magnetic field distribution of the magnetic recording medium will be described later.

The anisotropic magnetic field Hk of the magnetic recording medium is more than 5.0 kOe, preferably equal to or more than 5.1 kOe, more preferably equal to or more than 5.2 kOe, even more preferably equal to or more than 5.3 kOe, still preferably equal to or more than 5.4 kOe, still more preferably equal to or more than 5.5 kOe, and still even more preferably equal to or more than 5.6 kOe, mainly from a viewpoint of improving the positioning accuracy of the head. In addition, the anisotropic magnetic field Hk of the magnetic recording medium is less than 7.5 kOe, preferably equal to or less than 7.4 kOe, more preferably equal to or less than 7.3 kOe, even more preferably equal to or less than 7.2 kOe, still preferably equal to or less than 7.1 kOe, and still more preferably equal to or less than 7.0 kOe, from a viewpoint of improving the electromagnetic conversion characteristics and the head positioning accuracy. A method for adjusting the anisotropic magnetic field Hk of the magnetic recording medium will be described later.

Hexagonal Strontium Ferrite Powder

Average Particle Size

The average particle size of the hexagonal strontium ferrite powder included in the magnetic layer is 9 nm to 20 nm, from viewpoints of improving electromagnetic conversion characteristics and improving a head positioning accuracy. From viewpoints of further improving the electromagnetic conversion characteristics and the head positioning accuracy, the average particle size is preferably equal to or more than 10 nm, more preferably equal to or more than 12 nm, and even more preferably equal to or more than 14 nm. In addition, from a viewpoint of further improving the electromagnetic conversion characteristics and the head positioning accuracy, the average particle size is preferably equal to or smaller than 19 nm, more preferably equal to or smaller than 18 nm, even more preferably equal to or smaller than 17 nm, still preferably equal to or smaller than 16 nm, and still more preferably equal to or smaller than 15 nm.

In the invention and the specification, average particle sizes of various powder such as the hexagonal strontium ferrite powder and the like are values measured by the following method with a transmission electron microscope, unless otherwise noted.

The powder is imaged at an imaging magnification ratio of 100,000 with a transmission electron microscope, the image is printed on photographic printing paper or displayed on a display so that the total magnification ratio of 500,000 to obtain an image of particles configuring the powder. A target particle is selected from the obtained image of particles, an outline of the particle is traced with a digitizer, and a size of the particle (primary particle) is measured. The primary particle is an independent particle which is not aggregated.

The measurement described above is performed regarding 500 particles randomly extracted. An arithmetical mean of the particle size of 500 particles obtained as described above is an average particle size of the powder.

As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. The average particle size shown in examples which will be described later is a value measured by using transmission electron microscope H-9000 manufactured by Hitachi, Ltd. as the transmission electron microscope, and image analysis software KS-400 manufactured by Carl Zeiss as the image analysis software, unless otherwise noted. In the invention and the specification, the powder means an aggregate of a plurality of particles. For example, the ferromagnetic powder means an aggregate of a plurality of ferromagnetic particles. The aggregate of a plurality of particles is not limited to an embodiment in which particles configuring the aggregate directly come into contact with each other, but also includes an embodiment in which a binding agent, an additive, or the like which will be described later is interposed between the particles. A term, particles may be used for representing the powder.

As a method of collecting a sample powder from the magnetic recording medium in order to measure the particle size, a method disclosed in a paragraph 0015 of JP2011-048878A can be used, for example.

In the invention and the specification, unless otherwise noted,

(1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length,

(2) in a case where the shape of the particle is a planar shape or a columnar shape (here, a thickness or a height is smaller than a maximum long diameter of a plate surface or a bottom surface), the particle size is shown as a maximum long diameter of the plate surface or the bottom surface, and

(3) in a case where the shape of the particle is a sphere shape, a polyhedron shape, or an unspecified shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetical mean of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, in a case of the definition (2), the average particle size is an average plate diameter. In a case of the definition (3), the average particle size is an average diameter (also referred to as an average particle diameter).

The “hexagonal ferrite powder” is ferromagnetic powder in which a hexagonal ferrite type crystal structure is detected as a main phase by X-ray diffraction analysis. The main phase is a structure to which a diffraction peak at the highest intensity in the X-ray diffraction spectrum obtained by the X-ray diffraction analysis belongs. For example, in a case where the diffraction peak at the highest intensity in the X-ray diffraction spectrum obtained by the X-ray diffraction analysis belongs to the hexagonal ferrite type crystal structure, it is determined that the hexagonal ferrite type crystal structure is detected as the main phase. In a case where only a single structure is detected by the X-ray diffraction analysis, this detected structure is the main phase. The hexagonal ferrite type crystal structure includes at least an iron atom, a divalent metal atom, and an oxygen atom, as the constituent atom. A divalent metal atom is a metal atom which can be divalent cations as ions, and examples thereof include an alkaline earth metal atom such as a strontium atom, a barium atom, or a calcium atom, and a lead atom. In the invention and the specification, the term “hexagonal strontium ferrite powder” is powder in which a main divalent metal atom included in this powder is a strontium atom, and the hexagonal barium ferrite powder is a powder in which a main divalent metal atom included in this powder is a barium atom. The main divalent metal atom is a divalent metal atom occupying the greatest content in the divalent metal atom included in the powder based on atom %. Here, the rare earth atom is not included in the divalent metal atom. The hexagonal ferrite powder may or may not include the rare earth atom. The “rare earth atom” of the invention and the specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), an europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

As the crystal structure of the hexagonal ferrite, a magnetoplumbite type (also referred to as an “M type”), a W type, a Y type, and a Z type are known. The hexagonal strontium ferrite powder may have any crystal structure. The crystal structure can be confirmed by X-ray diffraction analysis. In the hexagonal strontium ferrite powder, a single crystal structure or two or more kinds of crystal structure can be detected by the X-ray diffraction analysis. For example, in one embodiment, in the hexagonal strontium ferrite powder, only the M type crystal structure can be detected by the X-ray diffraction analysis. For example, in a case where the constituent atom consists of an iron atom, a divalent metal atom, and an oxygen atom, the M type hexagonal ferrite is represented by a compositional formula of AFe₁₂O₁₉. Here, A represents a divalent metal atom, in a case where the hexagonal strontium ferrite powder has the M type, A is only a strontium atom (Sr), or in a case where a plurality of divalent metal atoms are included as A, the strontium atom (Sr) occupies the hexagonal strontium ferrite powder with the greatest content based on atom % as described above. A content of the divalent metal atom in the hexagonal strontium ferrite powder is generally determined according to the type of the crystal structure of the hexagonal ferrite and is not particularly limited. The same applies to a content of an iron atom and a content of an oxygen atom. The hexagonal strontium ferrite powder includes at least an iron atom, a strontium atom, and an oxygen atom, and may or may not include atoms other than these atoms. For example, the hexagonal strontium ferrite powder may or may not further include the rare earth atom. The magnetic properties of the hexagonal strontium ferrite powder can be controlled, for example, by the type and compositional ratio of the atoms constituting the crystal structure of the hexagonal ferrite. In addition, the anisotropic magnetic field Hk of the magnetic recording medium can be controlled, for example, by the type and compositional ratio of the atoms constituting the hexagonal strontium ferrite powder used for forming the magnetic layer. As an example, aluminum atoms tend to increase the anisotropic magnetic field Hk, and niobium atoms tend to decrease the anisotropic magnetic field Hk.

Manufacturing Method

As a manufacturing method of the hexagonal strontium ferrite powder, a glass crystallization method, a coprecipitation method, a reverse micelle method, or a hydrothermal synthesis method is used. Hereinafter, a manufacturing method using a glass crystallization method will be described as a specific embodiment. However, the hexagonal strontium ferrite powder can be manufactured by a method other than the glass crystallization method. As an example, for example, the hexagonal strontium ferrite powder can also be manufactured by a hydrothermal synthesis method. The hydrothermal synthesis method is a method for heating an aqueous solution including a hexagonal strontium ferrite precursor to convert the hexagonal strontium ferrite precursor into hexagonal strontium ferrite. Particularly, from a viewpoint of ease of manufacturing of the hexagonal strontium ferrite powder having a small activation volume, a continuous hydrothermal synthesis method for heating and pressurizing an aqueous solution including a hexagonal strontium ferrite precursor while sending the aqueous solution to a reaction flow path to convert the hexagonal strontium ferrite precursor into hexagonal strontium ferrite powder by using high reactivity of the heated and pressurized water, preferably water in a subcritical to supercritical state is preferable.

Manufacturing Method Using Glass Crystallization Method

The glass crystallization method generally includes the following steps.

(1) Step of melting a raw material mixture at least including a hexagonal strontium ferrite formation component and a glass formation component to obtain a molten material (melting step);

(2) Step of rapidly cooling the molten material to obtain an amorphous body (non-crystallization step);

(3) Step of heating the amorphous body and obtaining a crystallized material including hexagonal strontium ferrite particles and crystallized glass component precipitated by the heating (crystallization step); and

(4) Step of collecting the hexagonal strontium ferrite particles from the crystallized material (particle collecting step).

Hereinafter, the steps will be further described in detail.

Melting Step

The raw material mixture used in the glass crystallization method for obtaining the hexagonal strontium ferrite powder includes the hexagonal strontium ferrite formation component and the glass formation component. The glass formation component here is a component which may show a glass transition phenomenon and may be subjected to non-crystallization (vitrification), and in a general glass crystallization method, a B₂O₃ component is used. Even in a case of using the glass crystallization method for obtaining the hexagonal strontium ferrite powder, the B₂O₃ component can be used as the glass formation component. Each component included in the raw material mixture in the glass crystallization method is present as oxide or as various salt which may change into oxide during the step such as melting. The “B₂O₃ component” in the invention and the specification means to include B₂O₃ as it is, and various salts such as H₃BO₃ which may change to B₂O₃ during the step. The same applies to other components.

As the hexagonal strontium ferrite formation component included in the raw material mixture, oxide including an atom which is a constituent atom of the crystal structure of hexagonal strontium ferrite can be used. As specific examples, a Fe₂O₃ component, and a SrO component, and the like are used. In addition, in order to obtain hexagonal strontium ferrite powder including a barium atom, a BaO component can be used, and in order to obtain hexagonal strontium ferrite powder including calcium atom, a CaO component can be used.

In addition, in order to obtain a hexagonal strontium ferrite powder including one or more atoms other than iron atoms, divalent metal atoms, and oxygen atoms, an oxide component of such atoms is used. For example, in order to obtain a hexagonal strontium ferrite powder including aluminum atoms, an Al₂O₃ component (for example, Al(OH)₃ or the like) is used.

A content of each component in the raw material mixture is not particularly limited, and may be determined according to the composition of the hexagonal strontium ferrite powder to be obtained. The raw material mixture can be prepared by weighing and mixing various components. Then, the raw material mixture is melted and a molten material is obtained. A melting temperature may be set according to the composition of the raw material mixture, and is generally 1,000° C. to 1,500° C. A melting time may be suitably set so that the raw material mixture is sufficiently melted.

Non-Crystallization Step

Next, the obtained molten material is rapidly cooled to obtain an amorphous body. The rapid cooling can be performed in the same manner as in a rapid cooling step generally performed for obtaining an amorphous body in the glass crystallization method, and the rapid cooling step can be performed, for example, by a well-known method such as a method for pouring the molten material on a rapidly rotated water-cooled twin roller and performing rolling and rapid cooling.

Crystallization Step

After the rapid cooling, the obtained amorphous body is heated. By the heating, the hexagonal strontium ferrite particles and crystallized glass component can be precipitated. A particle size of the precipitated hexagonal strontium ferrite particles can be controlled depending on heating conditions. In a case where a heating temperature (crystallization temperature) for crystallization increases, a particle size of the hexagonal strontium ferrite particles to be precipitated tends to increase. By considering the above point, it is preferable to control the heating conditions, so as to obtain the hexagonal strontium ferrite powder having the average particle size in the range described above. In the one embodiment, the crystallization temperature is preferably in a range of 600° C. to 700° C. In addition, in the one embodiment, the heating time for crystallization (holding time at the crystallization temperature) is, for example, 0.1 to 24 hours, and preferably 0.15 to 8 hours.

Particle Collecting Step

The crystallized material obtained by heating the amorphous body includes the hexagonal strontium ferrite particles and the crystallized glass component. Therefore, in a case of performing acid treatment with respect to the crystallized material, the crystallized glass component surrounding the hexagonal strontium ferrite particles is dissolved and removed, thereby collecting the hexagonal strontium ferrite particles. Before the acid treatment, it is preferable to perform coarse crushing for increasing efficiency of the acid treatment. The coarse crushing may be performed by a dry or wet method. The coarse crushing conditions can be set according to a well-known method. The acid treatment for collecting particles can be performed by a method generally performed in the glass crystallization method such as acid treatment after heating. After that, by performing post-treatment such as classification (for example, centrifugation, decantation, magnetic separation, and the like), water washing, or drying, as necessary, the hexagonal strontium ferrite powder can be obtained. For example, it is possible to control the value of the anisotropic magnetic field distribution of a magnetic recording medium manufactured using the obtained hexagonal strontium ferrite powder, by adjusting the classification conditions (for example, the number of times of treatments, the treatment time, the centrifugal force applied in the centrifugation, the magnetic field strength in the magnetic separation method, the frequency in the case of an AC magnetic field, and the like).

Hereinabove, the specific embodiment of the manufacturing method of the hexagonal strontium ferrite powder has been described. However, the hexagonal strontium ferrite powder included in the magnetic layer of the magnetic recording medium described above is not limited to a hexagonal strontium ferrite powder manufactured by the specific embodiment.

Hereinafter, the magnetic recording medium will be further described in detail.

Magnetic Layer

Binding Agent

The magnetic recording medium can be a coating type magnetic recording medium and include a binding agent in the magnetic layer. As the binding agent, one or more kinds of resin are used. These resins may be a homopolymer or a copolymer. As the binding agent included in the magnetic layer, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins can be used as the binding agent even in the non-magnetic layer and/or a back coating layer which will be described later. For the binding agent described above, description disclosed in paragraphs 0029 to 0031 of JP2010-024113A can be referred to. An average molecular weight of the resin used as the binding agent can be, for example, 10,000 to 200,000 as a weight-average molecular weight. The weight-average molecular weight of the invention and the specification is a value obtained by performing polystyrene conversion of a value measured by gel permeation chromatography (GPC) under the following measurement conditions. As a measurement example, the following conditions can be used. The weight-average molecular weight shown in examples which will be described later is a value obtained by performing polystyrene conversion of a value measured under the following measurement conditions.

GPC device: HLC-8120 (manufactured by Tosoh Corporation)

Column: TSK gel Multipore HXL-M (manufactured by Tosoh Corporation, 7.8 mmlD (inner diameter)×30.0 cm)

Eluent: Tetrahydrofuran (THF)

A content of the binding agent used can be, for example, 1.0 to 30.0 parts by mass with respect to 100.0 parts by mass of the ferromagnetic powder. A content (filling percentage) of the ferromagnetic powder in the magnetic layer is preferably 50% to 90% by mass and more preferably 60% to 90% by mass. A high filling percentage of the ferromagnetic powder in the magnetic layer is preferable from a viewpoint of improvement of recording density. In addition, a curing agent can also be used together with a resin usable as the binding agent. As the curing agent, in one embodiment, a thermosetting compound which is a compound in which a curing reaction (crosslinking reaction) proceeds due to heating can be used, and in another embodiment, a photocurable compound in which a curing reaction (crosslinking reaction) proceeds due to light irradiation can be used. At least a part of the curing agent is included in the magnetic layer in a state of being reacted (crosslinked) with other components such as the binding agent, by proceeding the curing reaction in the magnetic layer forming step. This is the same for a layer formed using this composition in a case where the composition used to form another layer includes a curing agent. The preferred curing agent is a thermosetting compound, polyisocyanate is suitable. For details of the polyisocyanate, descriptions disclosed in paragraphs 0124 and 0125 of JP2011-216149A can be referred to, for example. A content of the curing agent in the magnetic layer forming composition can be, for example, 0 to 80.0 parts by mass, and is preferably 50.0 to 80.0 parts by mass with respect to 100.0 parts by mass of the binding agent.

Additives

The magnetic layer may include one or more kinds of additives, as necessary. As an example of the additive, the curing agent is used. Examples of the additive which can be included in the magnetic layer include a non-magnetic powder (for example, inorganic powder, carbon black, or the like), a lubricant, a dispersing agent, a dispersing assistant, an antibacterial agent, an antistatic agent, and an antioxidant. For example, for the lubricant, a description disclosed in paragraphs 0030 to 0033, 0035, and 0036 of JP2016-126817A can be referred to. The lubricant may be included in the non-magnetic layer which will be described later. For the lubricant which can be included in the non-magnetic layer, a description disclosed in paragraphs 0030, 0031, and 0034 and 0036 of JP2016-126817A can be referred to. For the dispersing agent, a description disclosed in paragraphs 0061 and 0071 of JP2012-133837A can be referred to. The dispersing agent may be added to a non-magnetic layer forming composition. For the dispersing agent which can be added to the non-magnetic layer forming composition, a description disclosed in paragraph 0061 of JP2012-133837A can be referred to. In addition, as the non-magnetic powder which may be included in the magnetic layer, non-magnetic powder which can function as an abrasive, non-magnetic powder (for example, non-magnetic colloidal particles) which can function as a projection formation agent which forms projections suitably protruded from the surface of the magnetic layer, and the like can be used. As the additives, a commercially available product can be suitably selected or the additive can be manufactured by a well-known method and used in accordance with any amount, in accordance with desired properties.

Non-Magnetic Layer

In the one embodiment, the magnetic recording medium can have a magnetic layer directly on a non-magnetic support. In addition, in the one embodiment, the magnetic recording medium may further include a non-magnetic layer including a non-magnetic powder between the non-magnetic support and the magnetic layer.

The non-magnetic powder used for the non-magnetic layer may be a powder of an inorganic substance (inorganic powder) or a powder of an organic substance (organic powder). In addition, carbon black and the like can be used. Examples of the inorganic substance include metal, metal oxide, metal carbonate, metal sulfate, metal nitride, metal carbide, and metal sulfide. These non-magnetic powders can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, a description of paragraphs 0040 and 0041 of JP2010-024113A can be referred to. The content (filling percentage) of the non-magnetic powder of the non-magnetic layer is preferably 50% to 90% by mass and more preferably 60% to 90% by mass.

The non-magnetic layer can include a binding agent or can also include additives. In regards to other details of a binding agent or additives of the non-magnetic layer, the well-known technology regarding the non-magnetic layer can be applied. In addition, in regards to the type and the content of the binding agent, and the type and the content of the additive, for example, the well-known technology regarding the magnetic layer can be applied.

The “non-magnetic layer” of the invention and the specification also includes a substantially non-magnetic layer including a small amount of ferromagnetic powder as impurities, or intentionally, together with the non-magnetic powder. Here, the substantially non-magnetic layer is a layer having a residual magnetic flux density equal to or smaller than 10 mT, a layer having coercivity equal to or smaller than 100 Oe, or a layer having a residual magnetic flux density equal to or smaller than 10 mT and coercivity equal to or smaller than 100 Oe. It is preferable that the non-magnetic layer does not have a residual magnetic flux density and coercivity.

Non-Magnetic Support

As the non-magnetic support (hereinafter, also simply referred to as a “support”), well-known components such as polyethylene terephthalate, polyethylene naphthalate, polyamide, polyamide imide, aromatic polyamide subjected to biaxial stretching are used. Among these, polyethylene terephthalate, polyethylene naphthalate, and polyamide are preferable. Corona discharge, plasma treatment, easy-bonding treatment, or heat treatment may be performed with respect to these supports in advance.

Back Coating Layer

The magnetic recording medium can also include or may not include a back coating layer including a non-magnetic powder on a surface of the non-magnetic support opposite to the surface provided with the magnetic layer. The back coating layer preferably includes one or both of carbon black and inorganic powder. The back coating layer can include a binding agent or can also include additives. In regards to the binding agent included in the back coating layer and additives, a well-known technology regarding the back coating layer can be applied, and a well-known technology regarding the list of the magnetic layer and/or the non-magnetic layer can also be applied. For example, for the back coating layer, descriptions disclosed in paragraphs 0018 to 0020 of JP2006-331625A and page 4, line 65, to page 5, line 38, of US7029774B can be referred to.

Non-Magnetic Support and Thickness of Each Layer

A thickness of the non-magnetic support is, for example, 3.0 to 80.0 μm, preferably 3.0 to 20.0 μm, and more preferably 3.0 to 10.0 μm.

A thickness of the magnetic layer can be optimized according to a saturation magnetization amount of a magnetic head used, a head gap length, a recording signal band, and the like, and is generally 10 nm to 150 nm, preferably 20 nm to 120 nm and more preferably 30 nm to 100 nm, from a viewpoint of realization of high-density recording. The magnetic layer may be at least one layer, or the magnetic layer can be separated to two or more layers having different magnetic properties, and a configuration regarding a well-known multilayered magnetic layer can be applied. A thickness of the magnetic layer which is separated into two or more layers is a total thickness of the layers.

The thickness of the non-magnetic layer is, for example, 0.05 to 3.0 μm, preferably 0.1 to 2.0 μm, and more preferably 0.1 to 1.5 μm.

A thickness of the back coating layer is preferably equal to or smaller than 0.9 μm and even more preferably 0.1 to 0.7 μm.

The thicknesses of each layer and the non-magnetic support of the magnetic recording medium can be acquired by a well-known film thickness measurement method. As an example, a cross section of the magnetic recording medium in a thickness direction is, for example, exposed by a well-known method of ion beams or microtome, and the exposed cross section is observed with a scanning electron microscope. In the cross section observation, various thicknesses can be acquired as a thickness acquired at one portion of the cross section, or an arithmetical mean of thicknesses acquired at a plurality of portions of two or more portions, for example, two portions which are randomly extracted.

Manufacturing Step

Manufacturing Step of Magnetic Recording Medium on which Servo Pattern is Formed

A step of manufacturing a composition for forming the magnetic layer, the non-magnetic layer, or the back coating layer can generally include at least a kneading step, a dispersing step, and a mixing step provided before and after these steps, as necessary. Each step may be divided into two or more stages. Various components may be added at an initial stage or in a middle stage of each step. In addition, each component may be separately added in two or more steps. In order to manufacture the magnetic recording medium, a well-known manufacturing technology related to the coating type magnetic recording medium can be used in a part of the step or in the entire step. For example, in the kneading step, an open kneader, a continuous kneader, a pressure kneader, or a kneader having a strong kneading force such as an extruder is preferably used. For the details of these kneading processes, descriptions disclosed in JP1989-106338A (JP-H01-106338A) and JP1989-079274A (JP-H01-079274A) can be referred to. In addition, in order to disperse the composition for forming each layer, glass beads can be used as dispersion beads. Further, as the dispersion beads, zirconia beads, titania beads, and steel beads which are dispersion beads having high specific gravity are suitable. These dispersion beads can be used by optimizing a particle diameter (bead diameter) and a filling percentage of these dispersion beads. As a dispersing device, a well-known dispersing devicecan be used. Each layer forming composition may be filtered by a well-known method before performing the coating step. The filtering can be performed by using a filter, for example. The filter used in the filtering, a filter having a hole diameter of 0.01 to 3μm (for example, filter made of glass fiber or filter made of polypropylene) can be used, for example.

The magnetic layer can be formed by directly applying the magnetic layer forming composition onto the non-magnetic support or performing multilayer coating with the non-magnetic layer forming composition in order or at the same time. The back coating layer can be formed by applying the back coating layer forming composition to the surface of the non-magnetic support opposite to a surface provided with the magnetic layer (or to be provided with the magnetic layer). For details of the coating for forming each layer, a description disclosed in a paragraph 0051 of JP2010-024113A can be referred to.

After the coating step, various processes such as an alignment process, a drying treatment, and a surface smoothing treatment (calender process) of the magnetic layer can be performed. For various steps, for example, a well-known technology disclosed in paragraphs 0052 to 0057 of JP2010-024113A can be referred to. For example, it is preferable to apply an alignment process to the coating layer of the magnetic layer forming composition while the coating layer is wet. For the alignment process, various well-known technologies disclosed in a paragraph 0067 of JP2010-231843A can be applied. For example, a homeotropic alignment process can be performed by a well-known method such as a method using a different polar facing magnet. In the alignment zone, a drying speed of the coating layer can be controlled by a temperature, an air flow of the dry air and/or a transporting speed of the magnetic tape in the alignment zone. In addition, the coating layer may be preliminarily dried before transporting to the alignment zone.

Formation of servo pattern

A servo pattern can be formed on the magnetic recording medium manufactured as described above by a well-known method, in order to realize tracking control of a magnetic head of the magnetic recording and reproducing device and control of a running speed of the magnetic recording medium. It is possible to form a servo pattern having a shape close to a designed shape by using a hexagonal strontium ferrite powder having an average particle size of 9 nm to 20 nm as the hexagonal strontium ferrite powder and manufacturing the magnetic recording medium having the anisotropic magnetic field Hk and the anisotropic magnetic field distribution in the ranges described above, and as a result, the inventors have surmised that it is possible to improve the head positioning accuracy of the magnetic recording medium having the magnetic layer including the hexagonal strontium ferrite powder in the servo system.

The “formation of the servo pattern” can be “recording of a servo signal”. The magnetic recording medium may be a tape-shaped magnetic recording medium (magnetic tape) or a disk-shaped magnetic recording medium (magnetic disk). Hereinafter, the formation of the servo pattern will be described using a magnetic tape as an example.

The servo pattern is generally formed along a longitudinal direction of the magnetic tape. As a method of control using a servo signal (servo control), timing-based servo (TBS), amplitude servo, or frequency servo is used.

As shown in European Computer Manufacturers Association (ECMA)-319, a timing-based servo system is used in a magnetic tape based on a linear tape-open (LTO) standard (generally referred to as an “LTO tape”). In this timing-based servo system, the servo pattern is configured by continuously disposing a plurality of pairs of magnetic stripes (also referred to as “servo stripes”) not parallel to each other in a longitudinal direction of the magnetic tape. In the invention and the specification, “timing-based servo pattern” is referred to as a servo pattern that enables head tracking in a timing-based servo system in the servo system. As described above, a reason for that the servo pattern is configured with one pair of magnetic stripes not parallel to each other is because a servo signal reading element passing on the servo pattern recognizes a passage position thereof. Specifically, one pair of the magnetic stripes are formed so that a gap thereof is continuously changed along the width direction of the magnetic tape, and a relative position of the servo pattern and the servo signal reading element can be recognized, by the reading of the gap thereof by the servo signal reading element. The information of this relative position can realize the tracking of a data track. Accordingly, a plurality of servo tracks are generally set on the servo pattern along the width direction of the magnetic tape.

The servo band is configured of a servo signal continuous in the longitudinal direction of the magnetic tape. A plurality of servo bands are normally provided on the magnetic tape. For example, the number thereof is 5 in the LTO tape. A region interposed between two adjacent servo bands is called a data band. The data band is configured of a plurality of data tracks and each data track corresponds to each servo track.

In one embodiment, as shown in JP2004-318983A, information showing the number of servo band (also referred to as “servo band identification (ID)” or “Unique Data Band Identification Method (UDIM) information”) is embedded in each servo band. This servo band ID is recorded by shifting a specific servo stripe among the plurality of pair of servo stripes in the servo band so that the position thereof is relatively displaced in the longitudinal direction of the magnetic tape. Specifically, the position of the shifted specific servo stripe among the plurality of pair of servo stripes is changed for each servo band. Accordingly, the recorded servo band ID becomes unique for each servo band, and therefore, the servo band can be uniquely specified by only reading one servo band by the servo signal reading element.

In a method of uniquely specifying the servo band, a staggered method as shown in ECMA-319 is used. In this staggered method, the group of one pair of magnetic stripes (servo stripe) not parallel to each other which are continuously disposed in the longitudinal direction of the magnetic tape is recorded so as to be shifted in the longitudinal direction of the magnetic tape for each servo band. A combination of this shifted servo band between the adjacent servo bands is set to be unique in the entire magnetic tape, and accordingly, the servo band can also be uniquely specified by reading of the servo pattern by two servo signal reading elements.

In addition, as shown in ECMA-319, information showing the position in the longitudinal direction of the magnetic tape (also referred to as “Longitudinal Position (LPOS) information”) is normally embedded in each servo band. This LPOS information is recorded so that the positions of one pair of servo stripes are shifted in the longitudinal direction of the magnetic tape, in the same manner as the UDIM information. However, unlike the UDIM information, the same signal is recorded on each servo band in this LPOS information.

Other information different from the UDIM information and the LPOS information can be embedded in the servo band. In this case, the embedded information may be different for each servo band as the UDIM information, or may be common in all of the servo bands, as the LPOS information.

In addition, as a method of embedding the information in the servo band, a method other than the method described above can be used. For example, a predetermined code may be recorded by thinning out a predetermined pair among the group of pairs of the servo stripes.

A head for servo signal recording (for servo pattern formation pattern) is also referred to as a servo write head. The servo write head includes pairs of gaps corresponding to the pairs of magnetic stripes by the number of servo bands. In general, a core and a coil are respectively connected to each of the pairs of gaps, and a magnetic field generated in the core can generate leakage magnetic field in the pairs of gaps, by supplying a current pulse to the coil. In a case of forming the servo pattern, by inputting a current pulse while causing the magnetic tape to run on the servo write head, the magnetic pattern corresponding to the pair of gaps is transferred to the magnetic tape, and the servo pattern can be formed. A width of each gap can be suitably set in accordance with a density of the servo patterns to be formed. The width of each gap can be set as, for example, equal to or smaller than 1 μm, 1 to 10 μm, or equal to or greater than 10 μm. In addition, as the servo write head, for example, a servo write head having a leakage magnetic field of 1,800 to 5,000 Oe and preferably 2,500 to 5,000 Oe can be used.

Before forming the servo pattern on the magnetic tape, a demagnetization (erasing) process is generally performed on the magnetic tape. This erasing process can be performed by applying a uniform magnetic field to the magnetic tape by using a DC magnet and an AC magnet. The erasing process includes direct current (DC) erasing and alternating current (AC) erasing. The AC erasing is performed by slowing decreasing the magnetic field strength, while reversing a direction of the magnetic field applied to the magnetic tape. Meanwhile, the DC erasing is performed by adding the magnetic field in one direction to the magnetic tape. The DC erasing further includes two methods. A first method is horizontal DC erasing of applying the magnetic field in one direction along a longitudinal direction of the magnetic tape. A second method is vertical DC erasing of applying the magnetic field in one direction along a thickness direction of the magnetic tape. The erasing process may be performed with respect to all of the magnetic tape or may be performed for each servo band of the magnetic tape.

A direction of the magnetic field to the servo pattern to be formed is determined in accordance with the direction of erasing. For example, in a case where the horizontal DC erasing is performed to the magnetic tape, the formation of the servo pattern is performed so that the direction of the magnetic field and the direction of erasing becomes opposite to each other. Accordingly, the output of the servo signal obtained by the reading of the servo pattern can be increased. As disclosed in JP2012-053940A, in a case where the magnetic pattern is transferred to the magnetic tape subjected to the vertical DC erasing by using the gap, the servo signal obtained by the reading of the formed servo pattern has a unipolar pulse shape. Meanwhile, in a case where the magnetic pattern is transferred to the magnetic tape subjected to the horizontal DC erasing by using the gap, the servo signal obtained by the reading of the formed servo pattern has a bipolar pulse shape.

In the one embodiment, the magnetic recording medium can be a magnetic tape having a timing-based servo pattern on a magnetic layer. The timing-based servo pattern is formed on the magnetic layer as a plurality of servo patterns having two or more different shapes by the servo write head. As an example, the plurality of servo patterns having two or more different shapes are continuously disposed at regular intervals for each of the plurality of servo patterns having the same shapes. As another example, different types of the servo patterns are alternately disposed.

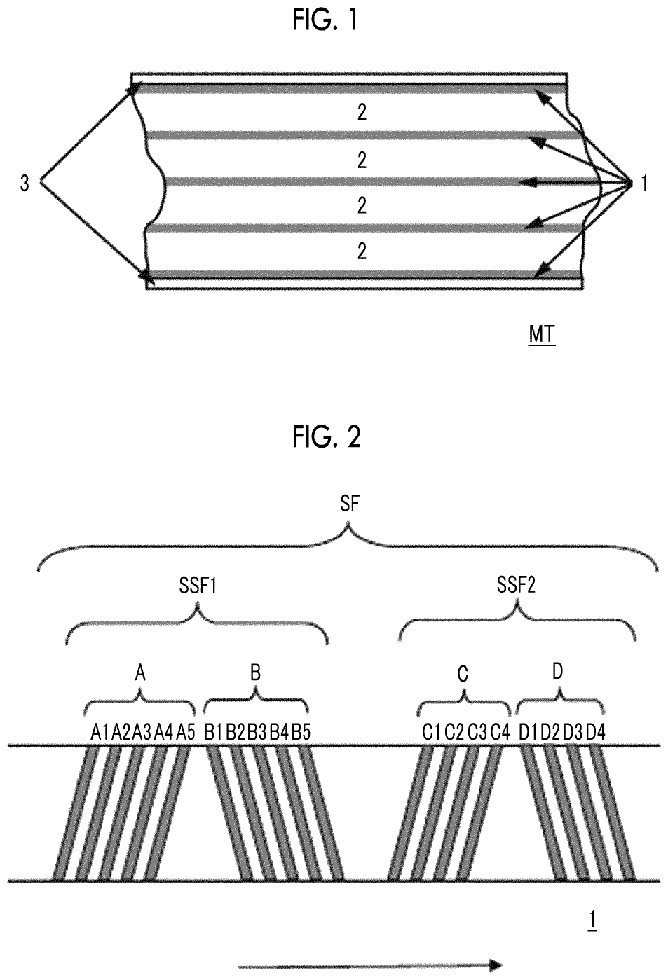

For example, a magnetic tape applied to a linear scan method widely used as a recording method of a magnetic tape device usually includes a plurality of regions where the servo pattern is formed (referred to as a “servo band”) in the magnetic layer along a longitudinal direction of the magnetic tape. A region interposed between two adjacent servo bands is called a data band. Data recording is performed on data bands, and a plurality of data tracks are formed in each data band along the longitudinal direction. FIG. 1 shows an example of disposition of data bands and servo bands. In FIG. 1, a plurality of servo bands 1 are disposed to be interposed between guide bands 3 in a magnetic layer of a magnetic tape MT. A plurality of regions 2 each of which is interposed between two servo bands are data bands. The servo pattern is a magnetized region and is formed by magnetizing a specific region of the magnetic layer by a servo write head. The region magnetized by the servo write head (position where a servo pattern is formed) is determined by standards. For example, in an LTO Ultrium format tape which is based on a local standard, a plurality of servo patterns tilted in a tape width direction as shown in FIG. 2 are formed on a servo band, in a case of manufacturing a magnetic tape. Specifically, in FIG. 2, a servo frame SF on the servo band 1 is configured with a servo sub-frame 1 (SSF1) and a servo sub-frame 2 (SSF2). The servo sub-frame 1 is configured with an A burst (in FIG. 2, reference numeral A) and a B burst (in FIG. 2, reference numeral B). The A burst is configured with servo patterns A1 to A5 and the B burst is configured with servo patterns B1 to B5. Meanwhile, the servo sub-frame 2 is configured with a C burst (in FIG. 2, reference numeral C) and a D burst (in FIG. 2, reference numeral D). The C burst is configured with servo patterns C1 to C4 and the D burst is configured with servo patterns D1 to D4. Such 18 servo patterns are disposed in the sub-frames in the arrangement of 5, 5, 4, 4, as the sets of 5 servo patterns and 4 servo patterns, and are used for recognizing the servo frames. FIG. 2 shows one servo frame, but a plurality of servo frames are disposed on each servo band in a running direction. In FIG. 2, an arrow shows the running direction.

In a case where the magnetic recording medium is a magnetic tape, the magnetic tape is generally accommodated in a magnetic tape cartridge and the magnetic tape cartridge is mounted in a magnetic recording and reproducing device.

In the magnetic tape cartridge, the magnetic tape is generally accommodated in a cartridge main body in a state of being wound around a reel. The reel is rotatably provided in the cartridge main body. As the magnetic tape cartridge, a single reel type magnetic tape cartridge including one reel in a cartridge main body and a twin reel type magnetic tape cartridge including two reels in a cartridge main body are widely used. In a case where the single reel type magnetic tape cartridge is mounted in the magnetic recording and reproducing device in order to record and/or reproduce data to the magnetic tape, the magnetic tape is drawn from the magnetic tape cartridge and wound around the reel on the magnetic recording and reproducing device side. A magnetic head is disposed on a magnetic tape transportation path from the magnetic tape cartridge to a winding reel. Sending and winding of the magnetic tape are performed between a reel (supply reel) on the magnetic tape cartridge side and a reel (winding reel) on the magnetic recording and reproducing device side. In the meantime, the magnetic head comes into contact with and slides on the surface of the magnetic layer of the magnetic tape, and accordingly, the recording and/or reproducing of the data is performed. With respect to this, in the twin reel type magnetic tape cartridge, both reels of the supply reel and the winding reel are provided in the magnetic tape cartridge. The magnetic tape cartridge may be any of single reel type magnetic tape cartridge and twin reel type magnetic tape cartridge. For other details of the magnetic tape cartridge, a well-known technology can be used.

Magnetic Recording and Reproducing Device

According to another aspect of the invention, there is provided a magnetic recording and reproducing device comprising: the magnetic recording medium; and a magnetic head.

In the invention and the specification, the “magnetic recording and reproducing device” means a device capable of performing at least one of the recording of data on the magnetic recording medium or the reproducing of data recorded on the magnetic recording medium. Such a device is generally called a drive. The magnetic recording and reproducing device can be a sliding type magnetic recording and reproducing device. The sliding type magnetic recording and reproducing device is a device in which a surface of a magnetic layer and a magnetic head are in contact with each other and slide on each other, in a case of performing the recording of data on a magnetic recording medium and/or the reproducing of the recorded data.

The magnetic head included in the magnetic recording and reproducing device can be a recording head capable of performing the recording of data on the magnetic recording medium, and can also be a reproducing head capable of performing the reproducing of data recorded on the magnetic recording medium. In addition, in the embodiment, the magnetic recording and reproducing device can include both of a recording head and a reproducing head as separate magnetic heads. In another embodiment, the magnetic head included in the magnetic recording and reproducing device can also have a configuration of comprising both of an element for recording data (recording element) and an element for reproducing data (reproducing element) in one magnetic head. Hereinafter, the element for recording data and the element for reproducing are collectively referred to as “elements for data”. As the reproducing head, a magnetic head (MR head) including a magnetoresistive (MR) element capable of reading data recorded on the magnetic tape with excellent sensitivity as the reproducing element is preferable. As the MR head, various well-known MR heads such as an Anisotropic Magnetoresistive (AMR) head, a Giant Magnetoresistive (GMR) head, or a Tunnel Magnetoresistive (TMR) head can be used. In addition, the magnetic head which performs the recording of data and/or the reproducing of data may include a servo signal reading element. Alternatively, as a head other than the magnetic head which performs the recording of data and/or the reproducing of data, a magnetic head (servo head) comprising a servo signal reading element may be included in the magnetic recording and reproducing device. The magnetic head which performs the recording of data and/or reproducing of the recorded data (hereinafter, also referred to as a “recording and reproducing head”) can include two servo signal reading elements, and each of the two servo signal reading elements can read two adjacent servo bands at the same time. One or a plurality of elements for data can be disposed between the two servo signal reading elements.

In the magnetic recording and reproducing device, the recording of data on the magnetic recording medium and/or the reproducing of data recorded on the magnetic recording medium can be performed by bringing the surface of the magnetic layer of the magnetic recording medium into contact with the magnetic head and sliding. The magnetic recording and reproducing device may include the magnetic recording medium according to the embodiment of the invention, and well-known technologies can be applied for the other configurations.

For example, in a case of recording data and/or reproducing the recorded data, first, tracking using a servo signal is performed. That is, as the servo signal reading element follows a predetermined servo track, the element for data is controlled to pass on the target data track. The movement of the data track is performed by changing the servo track to be read by the servo signal reading element in the tape width direction.

In addition, the recording and reproducing head can perform the recording and/or the reproducing with respect to other data bands. In this case, the servo signal reading element is moved to a predetermined servo band by using the UDIM information described above, and the tracking with respect to the servo band may be started.

### EXAMPLES

Hereinafter, the invention will be described more specifically with reference to examples. However, the invention is not limited to embodiments shown in the examples. “Parts” and “%” described below indicate “parts by mass” and “% by mass”, unless otherwise specified. “eq” indicates equivalent and a unit not convertible into SI unit. The following steps and evaluations were performed in the air at 23° C.±1° C., unless otherwise specified.

### Magnetic tape No. 1 (Comparative Example)

(1) List of Magnetic Layer Forming Composition

Magnetic Liquid
Ferromagnetic powder (hexagonal barium ferrite powder): 100.0 parts
SO₃Na group-containing polyurethane resin: 14.0 parts
(Weight-average molecular weight: 70,000, SO₃Na group: 0.4 meq/g)
Cyclohexanone: 150.0 parts
Methyl ethyl ketone: 150.0 parts
Oleic acid: 2.0 parts

Abrasive Solution
Abrasive solution A
   Alumina abrasive (average particle size: 100 nm): 3.0 parts
   SO₃Na group-containing polyurethane resin: 0.3 parts
   (Weight-average molecular weight: 70,000, SO₃Na group: 0.3 meq/g)
   Cyclohexanone: 26.7 parts
Abrasive solution B
   Diamond abrasive (average particle size: 100 nm): 1.0 part
   SO₃Na group-containing polyurethane resin: 0.1 parts
   (Weight-average molecular weight: 70,000, SO₃Na group: 0.3 meq/g)
   Cyclohexanone: 26.7 parts

Silica sol
Colloidal silica (average particle size: 100 nm): 0.2 part
Methyl ethyl ketone: 1.4 parts

Other components
Stearic acid: 2.0 parts
Butyl stearate: 6.0 part
Polyisocyanate (CORONATE manufactured by Tosoh Corporation): 2.5 parts

Finish Additive Solvent
Cyclohexanone: 200.0 parts
Methyl ethyl ketone: 200.0 parts

(2) List of Non-Magnetic Layer Forming Composition

Non-magnetic inorganic powder (α-iron oxide): 100.0 parts
Average particle size: 10 nm
Average acicular ratio: 1.9
Brunauer-Emmett-Teller (BET) specific surface area: 75 m²/g

Carbon black (average particle size: 20 nm): 25.0 parts

SO₃Na group-containing polyurethane resin: 18.0 parts

(Weight-average molecular weight: 70,000, SO₃Na group: 0.2 meq/g)

Stearic acid: 1.0 part

Cyclohexanone: 300.0 parts

Methyl ethyl ketone: 300.0 parts

(3) List of Back Coating Layer Forming Composition

Inorganic powder (a-iron oxide): 80.0 parts
Average particle size: 0.15 μm
Average acicular ratio: 7
BET specific surface area: 52 m_{2/}g

Carbon black (average particle size: 20 nm): 20.0 parts

Vinyl chloride copolymer: 13.0 parts

Sulfonic acid group-containing polyurethane resin: 6.0 parts

Phenylphosphonic acid: 3.0 parts

Cyclohexanone: 155.0 parts

Methyl ethyl ketone: 155.0 parts

Stearic acid: 3.0 parts

Butyl stearate: 3.0 part

Polyisocyanate: 5.0 parts

Cyclohexanone: 200.0 parts

(4) Manufacturing of Magnetic Tape

Various components of the magnetic liquid were dispersed to prepare a magnetic liquid. The dispersion process was performed for 24 hours using a batch type vertical sand mill. As dispersion beads, zirconia beads having a bead diameter of 0.5 mm were used.

The abrasive solution was prepared by the following method. A dispersion liquid prepared by dispersing the various components of the abrasive solution A and a dispersion liquid prepared by dispersing the various components of the abrasive solution B were prepared. After mixing these two types of dispersion liquids, an ultrasonic dispersion process was performed for 24 hours using a batch type ultrasonic device (20 kHz, 300 W) to prepare an abrasive solution.

These magnetic liquids and the abrasive solutions obtained as described above were mixed with the other components (silica sol, the other components, and the finishing additive solvent) and the ultrasonic dispersion process was performed with a batch type ultrasonic device (20 kHz, 300 W) for 30 minutes. After that, the obtained mixture was filtered with a filter having a hole diameter of 0.5 μm, and a magnetic layer forming composition was prepared.

For the non-magnetic layer forming composition, the various components were dispersed by using a batch type vertical sand mill for 24 hours. As dispersion beads, zirconia beads having a bead diameter of 0.1 mm were used. The obtained dispersion liquid was filtered with a filter having a hole diameter of 0.5 μm, and a non-magnetic layer forming composition was prepared.

For the back coating layer forming composition, the various components described above excluding the lubricant (stearic acid and butyl stearate), polyisocyanate, and 200.0 parts of cyclohexanone were kneaded and diluted by an open kneader. Then, the obtained mixed liquid was subjected to a dispersion process of 12 passes, with a transverse beads mill dispersing device by using zirconia beads having a particle diameter of 1 mm, by setting a bead filling percentage as 80 volume %, a circumferential speed of rotor distal end as 10 m/sec, and a retention time for 1 pass as 2 minutes. After that, the remaining components were added into the dispersion liquid as described above and stirred with a dissolver. The obtained dispersion liquid described above was filtered with a filter having a hole diameter of 1 μm and a back coating layer forming composition was prepared.

After that, a non-magnetic layer forming composition was applied on the surface of a biaxial stretching support made of polyethylene naphthalate having a thickness of 5.0 μm so as to have a thickness of 350 nm after drying and dried, and then a magnetic layer forming composition was applied thereon to have a thickness of 50 nm after drying, and a coating layer was formed. While the coating layer is wet, a homeotropic alignment process was performed by applying a magnetic field having a magnetic field strength of 0.6 T in a direction vertical to the surface of the coating layer, and the coating layer was dried. Then, a back coating layer forming composition was applied to the surface of the support opposite to the surface on which the non-magnetic layer and the magnetic layer were formed so that the thickness after drying becomes 0.4 μm, and dried, and a back coating layer was formed.

Then, a surface smoothing treatment (calender process) was performed with a calender configured of only a metal roll, at a speed of 100 m/min, linear pressure of 294 kN/m, and a surface temperature of calender roll of 92° C., and the heat treatment was performed in the environment of the atmosphere temperature of 70° C. for 36 hours. After the heat treatment, the resultant was slit to have a width of ½ inches to obtain a magnetic tape. 1 inch=0.0254 meters.

In a state where the magnetic layer of the obtained magnetic tape was demagnetized, servo patterns (timing-based servo patterns) having disposition and shapes according to the LTO Ultrium format were formed on the magnetic layer by using a servo write head mounted on a servo writer. Accordingly, a magnetic tape including data bands, servo bands, and guide bands in the disposition according to the LTO Ultrium format in the magnetic layer, and including servo patterns having the disposition and the shape according to the LTO Ultrium format on the servo band was obtained.

### Magnetic Tape No. 2 (Example)

A magnetic tape No. 2 was obtained in the same manner as in the manufacturing of the magnetic tape No. 1, except that the ferromagnetic powder was changed from hexagonal barium ferrite powder to hexagonal strontium ferrite powder manufactured by the following method.

Preparation of ferromagnetic powder (hexagonal strontium ferrite powder)

1736 g of SrCO₃, 662 g of H₃BO₃, 1340 g of Fe₂O₃, 52 g of Al(OH)₃, 35 g of CaCO3, and 146 g of BaCO₃ were weighed and mixed with a mixer to obtain a raw material mixture.

The obtained raw material mixture was dissolved in a platinum crucible at a melting temperature of 1420° C., and a tap hole provided on the bottom of the platinum crucible was heated while stirring the dissolved liquid, and the dissolved liquid was tapped in a rod shape at approximately 6 g/sec. The tap liquid was rapidly cooled and rolled with a water cooling twin roll to produce an amorphous body.

280 g of the obtained amorphous body was put into an electronic furnace, heated to 645° C. (crystallization temperature), and held at the same temperature for 5 hours, and hexagonal strontium ferrite particles were precipitated (crystallized).

Then, the crystallized material obtained as described above including the hexagonal strontium ferrite particles was coarse-crushed with a mortar and put in a glass bottle, 1000 g of zirconia beads having a particle diameter of 1 mm and 800 ml of an acetic acid aqueous solution having a concentration of 1% were added to this glass bottle, and a dispersion process was performed in a paint shaker for 3 hours. Then, the dispersion liquid was separated from beads and put in a stainless steel beaker. The dispersion liquid was left at a liquid temperature of 95° C. for 3.5 hours, subjected to a dissolving process of a glass component, precipitated with a centrifugal separator, decantation was repeated for washing, and drying was performed in a heating furnace at a furnace inner temperature of 110° C. for 6 hours.

The powder after the drying was subjected to a classification treatment by the following method. In the classification treatment, among the particles included in the liquid subjected to centrifugation, particles having a small particle size were dispersed in the supernatant after centrifugation, and particles having a large particle size precipitated as a precipitate.

10 g of the powder after drying, 3.5 g of citric acid, 300 g of zirconia beads, and 55 g of pure water were put in a sealed container, and subjected to a dispersion treatment with a paint shaker for 3.8 hours. Then, 360 g of pure water was added to separate the beads and the liquid, and after centrifugation to precipitate the powder, the supernatant was removed. Thereafter, 380 g of pure water was added, redispersion treatment was performed with a homogenizer, pH was adjusted to 9.6 with ammonia water having a concentration of 25%, and a dispersion liquid A in which hexagonal strontium ferrite powder particles were dispersed was obtained.

This dispersion liquid A was subjected to the first centrifugation at 15,200 G (G: gravitational acceleration) for 150 minutes, and then the precipitate and the supernatant were separated by decantation. Subsequently, the obtained supernatant was subjected to a second centrifugation at 15,200 G for 260 minutes, and then the supernatant and the precipitate were separated by decantation. The obtained precipitate was dried in a heating furnace at a furnace inner temperature of 95° C. for 6 hours to obtain hexagonal strontium ferrite powder.

### Magnetic Tape No. 3 (Comparative Example)

A magnetic tape No. 3 was manufactured in the same manner as in the manufacturing of the magnetic tape No. 2, except that the crystallization temperature of the amorphous body was changed to 628° C., the first centrifugation performed on the dispersion liquid A was performed at 15,200 G for 180 minutes, and the second centrifugation performed on the supernatant obtained after the first centrifugation was performed at 15,200 G for 270 minutes.

### Magnetic Tape No. 4 (Example)

A magnetic tape No. 4 was manufactured in the same manner as in the manufacturing of the magnetic tape No. 2, except that the crystallization temperature of the amorphous body was changed to 630° C., the first centrifugation performed on the dispersion liquid A was performed at 15,200 G for 175 minutes, and the second centrifugation performed on the supernatant obtained after the first centrifugation was performed at 15,200 G for 270 minutes.

### Magnetic Tape No. 5 (Example)

A magnetic tape No. 5 was manufactured in the same manner as in the manufacturing of the magnetic tape No. 2, except that the crystallization temperature of the amorphous body was changed to 656° C.

### Magnetic tape No. 6 (Comparative Example)

A magnetic tape No. 6 was manufactured in the same manner as in the manufacturing of the magnetic tape No. 2, except that the crystallization temperature of the amorphous body was changed to 659° C.

### Magnetic Tape No. 7 (Comparative Example)

A magnetic tape No. 7 was manufactured in the same manner as in the manufacturing of the magnetic tape No. 2, except that 23 g of Nb₂O₅ was added when manufacturing the raw material mixture of the hexagonal strontium ferrite powder.

### Magnetic tape No. 8 (Example)

A magnetic tape No. 8 was manufactured in the same manner as in the manufacturing of the magnetic tape No. 2, except that the crystallization temperature of the amorphous body was changed to 652° C.

### Magnetic Tape No. 9 (Example)

A magnetic tape No. 9 was manufactured in the same manner as in the manufacturing of the magnetic tape No. 2, except that 78 g of Al(OH)₃ was added in a case of manufacturing the raw material mixture of the hexagonal strontium ferrite powder and the crystallization temperature of the amorphous body was changed to 660° C.

### Magnetic tape No. 10 (Comparative Example)

A magnetic tape No. 10 was manufactured in the same manner as in the manufacturing of the magnetic tape No. 2, except that the crystallization temperature of the amorphous body was changed to 665° C.

### Magnetic tape No. 11 (Comparative Example)

A magnetic tape No. 11 was manufactured in the same manner as in the manufacturing of the magnetic tape No. 2, except that the classification process performed on the dried powder was changed to the following process.

In the classification process, the first centrifugation performed on the dispersion liquid A was performed at 15,200 G for 145 minutes, and the second centrifugation performed on the supernatant obtained after the first centrifugation was performed at 15,200 G for 150 minutes. After the second centrifugation, the supernatant and the precipitate were separated by decantation. The obtained supernatant was subjected to a third centrifugation at 15,200 G for 240 minutes, and then the supernatant and the precipitate were separated by decantation. The pure water was added to the obtained precipitate and dispersed again with ultrasonic waves, a fourth centrifugation was performed at 15,200 G for 260 minutes, and the supernatant and the precipitate were separated by decantation. After pure water was added to the obtained precipitate and dispersed again by ultrasonic waves, the fifth centrifugation was performed at 15,200 G for 280 minutes, and the supernatant and the precipitate were separated by decantation. The obtained precipitate was dried in a heating furnace at a furnace inner temperature of 95° C. for 6 hours to obtain hexagonal strontium ferrite powder.

### Magnetic Tape No. 12 (Example)

A magnetic tape No. 12 was manufactured in the same manner as in the manufacturing of the magnetic tape No. 11, except that the fifth centrifugation was not performed.

### Magnetic tape No. 13 (Example)

A magnetic tape No. 13 was manufactured in the same manner as in the manufacturing of the magnetic tape No. 2, except that the first centrifugation performed on the dispersion liquid A was performed at 15,200 G for 180 minutes, and the second centrifugation performed on the supernatant obtained after the first centrifugation was performed at 15,200 G for 300 minutes.

### Magnetic tape No. 14 (Comparative Example)

A magnetic tape No. 14 was manufactured in the same manner as in the manufacturing of the magnetic tape No. 2, except that the first centrifugation performed on the dispersion liquid A was performed at 15,200 G for 200 minutes, and the second centrifugation performed on the supernatant obtained after the first centrifugation was performed at 15,200 G for 330 minutes.

For each hexagonal strontium ferrite powder prepared by the above method, elemental analysis and crystal structure analysis were performed by the following methods.

A sample powder (12 mg) was collected from each powder obtained above, and a container (for example, a beaker) containing the sample powder and 10 ml of 4 mol/L hydrochloric acid was held on a hot plate at a set temperature of 80° C. for 3 hours, and was completely dissolved. The obtained dissolved liquid was filtered with a membrane filter having a hole diameter of 0.1 μm, and elemental analysis of the filtrate obtained as described above was performed by an inductively coupled plasma (ICP) analysis device. As a result of elemental analysis, it was confirmed that the powder obtained above was a hexagonal strontium ferrite powder.

In addition, a sample powder was separately collected from each of the powders obtained above, and subjected to X-ray diffraction analysis. As a result of the analysis, the powder obtained as described above showed a crystal structure of magnetoplumbite type (M type) hexagonal ferrite. In addition, a crystal phase detected by the X-ray diffraction analysis was a magnetoplumbite type single phase. The X-ray diffraction analysis was performed by scanning CuKa radiation under the conditions of a voltage of 45 kV and an intensity of 40 mA, and measuring the X-ray diffraction pattern under the following conditions.

PANalytical X′Pert Pro diffractometer, PIXcel detector

Soller slit of incident beam and diffraction beam: 0.017 radians

Fixed angle of dispersion slit: ¼ degrees

Mask: 10 mm

Scattering prevention slit: ¼ degrees

Measurement mode: continuous

Measurement time per 1 stage: 3 seconds

Measurement speed: 0.017 degrees per second

Measurement step: 0.05 degrees

Evaluation method

(1) Anisotropic magnetic field distribution and anisotropic magnetic field Hk of magnetic recording medium (magnetic tape)

A sample having a length of 3 cm was cut out from each magnetic tape of the examples and the comparative examples, and an anisotropic magnetic field distribution and an anisotropic magnetic field Hk of this sample were obtained by the method described above using TM-VSM 6050-SM manufactured by Tamagawa Co. Ltd. as a VSM. Hm=50,000 Oe, H1=500 Oe, the magnetic field applied in the x direction for each measurement was the magnetic field applied for the immediately preceding measurement+500 Oe, and measurement was performed up to H60=30000 Oe.

(2) Average Particle Size of Ferromagnetic Powder

Regarding each ferromagnetic powder used in the examples and the comparative examples, an average particle size was obtained by the method described above using a transmission electron microscope H-9000 manufactured by Hitachi, Ltd. as the transmission electron microscope, and image analysis software KS-400 manufactured by Carl Zeiss as the image analysis software.

(3) Electromagnetic conversion characteristics (noise evaluation)

A magnetic signal was recorded on each magnetic tape of the examples and the comparative examples in a tape longitudinal direction under the following conditions and the recorded magnetic signal was reproduced with an MR head. A reproduction signal was frequency-analyzed with a spectrum analyzer manufactured by Shibasoku Co., Ltd. and the noise integrated in the range of 0 to 600 kfci were evaluated according to the following standards. The unit, kfci, is a unit of linear recording density (not able to be converted into the SI unit system), and fci is flux change per inch.

Recording and Reproduction Conditions

Recording: recording track width: 5μm

Recording gap: 0.17 μm

Head saturation magnetic flux density Bs: 1.8T

Recording wavelength: 300 kfci

Reproduction: Reproduction track width: 0.4 μm

Distance between shields (sh- sh distance): 0.08 μm

### (Evaluation Standard)

4: Low noise and good signal.

3: The signal is good although noise is observed.

2: The noise is great and the signal is unclear.

1: Noise and signal cannot be distinguished or recorded.

(4) PES (Position Error Signal)

A PES obtained by the following method can be an index of the head positioning accuracy in the servo system. The smaller value of PES means a higher head positioning accuracy in the servo system.

For each of the magnetic tapes of the example and the comparative example, the servo pattern was read by a verify head on a servo writer used for forming the servo pattern. The verify head is a reading magnetic head that is used for confirming quality of the servo pattern formed on the magnetic tape, and reading elements are disposed at positions corresponding to the positions of the servo pattern (specifically, position in the width direction of the magnetic tape), in the same manner as the magnetic head of a well-known magnetic recording and reproducing device.

A well-known PES arithmetic circuit which calculates the head positioning accuracy of the servo system as the PES from an electric signal obtained by reading the servo pattern by the verify head is connected to the verify head. The PES arithmetic circuit calculates a displacement from the input electric signal (pulse signal) in the width direction of the magnetic tape, as required, and a value obtained by applying a high pass filter (cut off value: 500 cycles/m) with respect to temporal change information (signal) of this displacement was calculated as PES. Table 1 shows the calculated PES.

Table 1 shows results of the above evaluations. In the column of the type of ferromagnetic powder in Table 1, “BF” is a hexagonal barium ferrite powder, and “SR” is a hexagonal strontium ferrite powder.

TABLE 1

| | | Ferromagnetic powder | | | | | |
|---|---|---|---|---|---|---|---|
| | | | Average particle | Anisotropic | Anisotropic | Electromagnetic | |
| Example/Comparative | Magnetic | | size | magnetic field | magnetic field | conversion | |
| Example | tape No. | Type | (nm) | Hk (kOe) | distribution | characteristics | PES |
| Comparative Example | 1 | BF | 20 | 5.1 | 0.70 | 2 | 10.9 |
| Example | 2 | SR | 15 | 5.9 | 0.91 | 4 | 9.1 |
| Comparative Example | 3 | SR | 8 | 5.1 | 0.95 | 1 | 13.1 |
| Example | 4 | SR | 10 | 5.3 | 1.09 | 3 | 9.4 |
| Example | 5 | SR | 19 | 6.7 | 0.82 | 3 | 10.1 |
| Comparative Example | 6 | SR | 21 | 6.8 | 0.84 | 2 | 11.2 |
| Comparative Example | 7 | SR | 13 | 4.8 | 0.95 | 3 | 11.4 |
| Example | 8 | SR | 15 | 5.2 | 1.05 | 3 | 9.7 |
| Example | 9 | SR | 15 | 7.3 | 1.16 | 3 | 9.9 |
| Comparative Example | 10 | SR | 17 | 7.6 | 1.24 | 2 | 11.8 |
| Comparative Example | 11 | SR | 15 | 6.1 | 0.73 | 2 | 13.6 |
| Example | 12 | SR | 15 | 6.0 | 0.77 | 3 | 10.2 |
| Example | 13 | SR | 14 | 6.2 | 1.18 | 3 | 9.5 |
| Comparative Example | 14 | SR | 15 | 6.3 | 1.22 | 2 | 13.1 |

From the evaluation results of the examples and comparative examples shown in Table 1, in the magnetic recording medium including the hexagonal strontium ferrite powder in the magnetic layer, the anisotropic magnetic field Hk, the anisotropic magnetic field distribution, and the average particle size of the hexagonal strontium ferrite powder contribute to an increase in accuracy (head positioning accuracy) of the magnetic head following the data track in the servo system (small value of PES) and the improvement in electromagnetic conversion characteristics.

One embodiment of the invention is effective in a technical field of a magnetic recording medium for high-density recording.

What is claimed is:

1. A magnetic recording medium comprising:
a non-magnetic support; and
a magnetic layer including a ferromagnetic powder,
wherein an anisotropic magnetic field Hk is more than 5.0 kOe and less than 7.5 kOe,
an anisotropic magnetic field distribution is more than 0.75 and less than 1.20,
the magnetic layer has a servo pattern,
the ferromagnetic powder is a hexagonal strontium ferrite powder, and
an average particle size of the hexagonal strontium ferrite powder is 9 nm to 20 nm.

2. The magnetic recording medium according to claim 1,
wherein the anisotropic magnetic field distribution is 0.77 to 1.18.

3. The magnetic recording medium according to claim1,
wherein the anisotropic magnetic field Hk is 5.1 kOe to 7.3 kOe.

4. The magnetic recording medium according to claim 2,
wherein the anisotropic magnetic field Hk is 5.1 kOe to 7.3 kOe.

5. The magnetic recording medium according to claim 1,
wherein the average particle size of the hexagonal strontium ferrite powder is 10 nm to 20 nm.

6. The magnetic recording medium according to claim 1, further comprising:
a non-magnetic layer including a non-magnetic powder between the non-magnetic support and the magnetic layer.

7. The magnetic recording medium according to claim 1, further comprising:
a back coating layer including a non-magnetic powder on a surface of the non-magnetic support opposite to a surface provided with the magnetic layer.

8. The magnetic recording medium according to claim 1,
wherein the magnetic recording medium is a magnetic tape.

9. The magnetic recording medium according to claim 1,
wherein the servo pattern is a timing-based servo pattern.

10. A magnetic recording and reproducing device comprising:
a magnetic recording medium; and
a magnetic head,
wherein the magnetic recording medium is a magnetic recording medium comprising:
a non-magnetic support; and
a magnetic layer including a ferromagnetic powder,
wherein an anisotropic magnetic field Hk is more than 5.0 kOe and less than 7.5 kOe,
an anisotropic magnetic field distribution is more than 0.75 and less than 1.20,
the magnetic layer has a servo pattern,
the ferromagnetic powder is a hexagonal strontium ferrite powder, and
an average particle size of the hexagonal strontium ferrite powder is 9 nm to 20 nm.

11. The magnetic recording and reproducing device according to claim 10,
wherein the anisotropic magnetic field distribution is 0.77 to 1.18.

12. The magnetic recording and reproducing device according to claim 10,
wherein the anisotropic magnetic field Hk is 5.1 kOe to 7.3 kOe.

13. The magnetic recording and reproducing device according to claim 11,
wherein the anisotropic magnetic field Hk is 5.1 kOe to 7.3 kOe.

14. The magnetic recording and reproducing device according to claim 10,
wherein the average particle size of the hexagonal strontium ferrite powder is 10 nm to 20 nm.

15. The magnetic recording and reproducing device according to claim 10,
wherein the magnetic recording medium further comprises a non-magnetic layer including a non-magnetic powder between the non-magnetic support and the magnetic layer.

16. The magnetic recording and reproducing device according to claim 10,
wherein the magnetic recording medium further comprises a back coating layer including a non-magnetic powder on a surface of the non-magnetic support opposite to a surface provided with the magnetic layer.

17. The magnetic recording and reproducing device according to claim 10,
wherein the magnetic recording medium is a magnetic tape.

18. The magnetic recording and reproducing device according to claim 10,
wherein the servo pattern is a timing-based servo pattern.
